(19) United States
(12) Patent Application Publication
(10) Pub. No.: US 2011/0003062 A1
(43) Pub. Date: Jan. 6, 2011

(54) PROTEIN FORTIFIED PEANUT BUTTER

(76) Inventor: Kerin Kennedy, Erie, CO (US)

Correspondence Address: HOLLAND & HART, LLP, P.O BOX 8749, DENVER, CO, 80201, US

(21) Appl. No.: 12/497,003

(22) Filed: Jul. 2, 2009

(51) Int. Cl. A23L 1/38

(52) U.S. Cl. 426/633

(57) ABSTRACT

A pea protein fortified peanut butter generally comprising from about 25 to about 90% by weight ground peanuts, from about 2 to about 75% by weight isolated pea protein, from about 0.001 to about 5% by weight salt, from about 0.001 to about 30% by weight sugar, from about 0.001 to about 15% by weight palm or peanut oil, from about 0.5 to about 10% by weight peanut butter stabilizers such as mono and diglycerides from vegetable or animal origin, from about 0.0001 to about 10% by weight natural flavorings, and from about 0.1 to about 50% by weight inclusions, such as honey bits, chocolate chips, banana pieces, dried fruit pieces, peanut bits, and combinations thereof.

### BACKGROUND

For hundreds of years, Americans have been consuming peanut butter as a diet staple. Although peanut butter is often times considered a children's food, adults consume it in many different forms, such as sandwiches, crackers/snacks, pretzels, and cookies. Some estimate that peanut butter is a 900 million dollar a year industry with specialty varieties commanding about 25% of the peanut butter market.

Peanut butter contains several beneficial ingredients such as vitamin E and niacin. However, peanut butter also traditionally has high levels of fat with moderate amounts of protein (approximately 20-25%). In recent years, manufacturers have added new varieties of peanut butter in hopes of capturing more sales. They have responded to the problem of high fat, by offering reduced fat varieties. They have also added new flavor varieties and varieties with less sodium and sugar.

There is, however, still a need for improving the protein content of peanut butter such that parents can feel better about feeding what is otherwise an inherently high fat product to their children as a main meal component.

### SUMMARY

In one embodiment a protein fortified peanut butter generally comprises: from about 25 to about 90% by weight ground peanuts; from about 2 to about 75% by weight isolated pea protein; from about 0.001 to about 5% by weight salt; from about 0.001 to about 30% by weight sugar; from about 0.001 to about 15% by weight palm or peanut oil; from about 0.5 to about 10% by weight peanut butter stabilizers such as mono and diglycerides from vegetable or animal origin; from about 0.0001 to about 10% by weight natural flavorings; and from about 0.1 to about 50% by weight inclusions.

In another embodiment, the protein fortified peanut butter composition comprises: from about 40 to about 90% by weight ground peanuts; from about 10 to about 60% by weight isolated pea protein; from about 0.01 to about 10% by weight salt; from about 0.01 to about 30% by weight sweetener; from about 1 to about 15% by weight oil; from about 0.01 to about 5% by weight peanut butter stabilizers; and from about 0.001 to about 10% by weight natural flavorings.

Various inclusions may also be added to enhance the flavor and consistency of the peanut butter. Some examples of desirable inclusions include honey bits, chocolate chips, banana pieces, dried fruit pieces, peanut bits, and the like.

### DETAILED DESCRIPTION

The present invention relates generally to peanut butter or peanut spread, and particularly to a pea protein fortified peanut butter. Generally, the manufacturing process involves grinding peanuts and adding salt, sugar, flavorings, fats, and oils. Also, fortifying protein sources are combined with the peanut butter. Accordingly, the protein content of the peanut butter is improved thereby enhancing the nutritional value of this popular food item.

Broadly, the protein fortified peanut butter may include protein sources from animal or vegetable origin, but preferably from legume sources (peanut, pea, bean, etc). Protein sources could also be from soy or other vegetable source. Fats or oils may be added as desired including peanut oil, palm fruit oil, canola, corn, soybean, and other vegetable sources. Salt may also be added depending upon desired taste. Starches, maltodextrins, flours, or other like items can be added to adjust thickness and fat levels of the final product. Monoglycerides and/or diglycerides may be added as desired to help keep a homogeneous product consistency.

Pea protein isolate is derived from pisum sativum and contains 80-95% protein. A suitable pea protein isolate is available from Roquette America of Keokuk, Iowa (www.pea-protein.com) and marketed under the designations Nutralys® S85F and F85M. The use of pea protein isolate in peanut butter is particularly advantageous because it has a similar flavor as peanuts. Conventional sources of protein, such as whey, sometimes have a very strong, incompatible, taste. Pea protein is also considered non-allergenic as opposed to other sources of protein that may contain dairy components, which are often considered an allergen.

Sweeteners may also be added, such as sugar, confectioner sugar, dextrose, fructose, molasses, honey, artificial sweeteners, polyols, and stevia derivatives, to name a few. Other natural flavorings to enhance product flavor may be added as well. Various inclusions (i.e. small pieces or bits) may be added to enhance the flavor and consistency of the peanut butter. Some examples of desirable inclusions include honey bits, chocolate chips, banana pieces, dried fruit pieces, peanut bits, and the like.

The composition of the protein fortified peanut butter generally comprises: from about 25 to about 90% by weight ground peanuts; from about 2 to about 75% by weight isolated pea protein; from about 0.001 to about 5% by weight salt; from about 0.001 to about 30% by weight sugar; from about 0.001 to about 15% by weight palm or peanut oil; from about 0.5 to about 10% by weight peanut butter stabilizers such as mono and diglycerides from vegetable or animal origin; from about 0.0001 to about 10% by weight natural flavorings; and from about 0.1 to about 50% by weight inclusions.

In another embodiment, the protein fortified peanut butter composition comprises: from about 40 to about 90% by weight ground peanuts; from about 10 to about 60% by weight isolated pea protein; from about 0.01 to about 10% by weight salt; from about 0.01 to about 30% by weight sweetener; from about 1 to about 15% by weight palm oil; from about 0.01 to about 5% by weight peanut butter stabilizers; and from about 0.001 to about 10% by weight natural flavorings.

The protein fortified peanut butter uses a conventional method for the preparation of the peanut butter or peanut spread. A typical peanut butter spread is prepared. Peanuts of the Runner and Spanish type are employed and various varieties could also be used including those from the Virginia or Valencia variety.

Peanuts are roasted at a suitable temperature of around 350° F. for approximately 20-50 minutes. The roasted peanuts are discharged and rapidly cooled to a temperature of about 100° F. or less. The roasted peanuts are blanched and then sorted and blended in a conventional manner. The peanuts are then ground into a paste at which time the isolated pea protein and the other ingredients are also added and blended (salt, sweetener, stabilizer, flavorings, and fats).

Unless otherwise indicated, all numbers or expressions, such as those expressing dimensions, physical characteristics, etc., used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

In addition, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

Accordingly, the present invention has been described with some degree of particularity directed to the exemplary embodiments. It should be appreciated, though, that the present invention is defined by the following claims construed in light of the prior art so that modifications or changes may be made to the exemplary embodiments without departing from the inventive concepts contained herein.

What is claimed is:

1. A peanut butter composition, comprising:
from about 25 to about 90% by weight ground peanuts;
from about 2 to about 75% by weight pea protein isolate;
from about 0.001 to about 15% by weight oil; and
from about 0.5 to about 10% by weight peanut butter stabilizer.

2. The peanut butter composition of claim 1, including from about 0.001 to about 10% by weight salt.

3. The peanut butter composition of claim 2, including from about 0.001 to about 30% by weight sweetener.

4. The peanut butter composition of claim 3, including from about 0.0001 to about 10% by weight natural flavorings.

5. The peanut butter composition of claim 4 including from about 0.1 to about 50% by weight of at least one inclusion.

6. The peanut butter composition of claim 5, wherein said at least one inclusion is selected from the group consisting of honey bits, chocolate chips, banana pieces, dried fruit pieces, peanut bits, and combinations thereof.

7. The peanut butter composition of claim 4, wherein said oil is palm oil.

8. The peanut butter composition of claim 4, wherein said oil is peanut oil.

9. The peanut butter composition of claim 4, wherein the weight percent of ground peanuts is from about 40 to about 90%.

10. The peanut butter composition of claim 4, wherein the weight percent of pea protein isolate is from about 10 to about 60%.

11. The peanut butter composition of claim 4, wherein the weight percent of salt is from about 0.01 to about 5%.

12. The peanut butter composition of claim 4, wherein the weight percent of sweetener is from about 0.01 to about 30%.

13. The peanut butter composition of claim 4, wherein the weight percent of oil is from about 1 to about 15%.

14. The peanut butter composition of claim 4, wherein the weight percent of peanut butter stabilizer is from about 0.01 to about 5%.

15. The peanut butter composition of claim 4, wherein the weight percent of natural flavorings is from about 0.001 to about 10%.

16. A peanut butter composition, comprising:
from about 40 to about 90% by weight ground peanuts;
from about 10 to about 60% by weight pea protein isolate;
from about 0.01 to about 5% by weight salt;
from about 0.01 to about 30% by weight sweetener;
from about 1 to about 15% by weight oil;
from about 0.01 to about 5% by weight peanut butter stabilizer;
from about 0.001 to about 10% by weight natural flavorings; and
from about 0.1 to about 50% by weight of at least one inclusion.

17. The peanut butter composition of claim 16, wherein said at least one inclusion is selected from the group consisting of honey bits, chocolate chips, banana pieces, dried fruit pieces, peanut bits, and combinations thereof.
